(19) United States
(12) Patent Application Publication
(10) Pub. No.: US 2017/0026439 A1
(43) Pub. Date: Jan. 26, 2017

(54) DEVICES AND METHODS FOR FACILITATING VIDEO AND GRAPHICS STREAMS IN REMOTE DISPLAY APPLICATIONS

(71) Applicant: QUALCOMM Incorporated, San Diego, CA (US)

(72) Inventors: Lochan Verma, San Diego, CA (US); Vijayalakshmi Rajasundaram Raveendran, Del Mar, CA (US)

(21) Appl. No.: 15/213,041

(22) Filed: Jul. 18, 2016

Related U.S. Application Data
(60) Provisional application No. 62/195,745, filed on Jul. 22, 2015.

(51) Int. Cl. H04L 29/06; H04L 29/08; H04W 4/00

(52) U.S. Cl. CPC H04L 65/60; H04W 4/008; H04L 65/608; H04L 67/02; H04W 84/12

(57) ABSTRACT

Source and sink devices are adapted to facilitate streaming of screen content data. According to one example, a source device can capture video data and graphics data for one or more frames. The video data may be transmitted via a first protocol path and the graphics data may be transmitted via a second protocol path, where the second protocol path is different from the first protocol path. The sink device may receive the video data and graphics data, and may render the video data and graphics data for the one or more frames. Other aspects, embodiments, and features are also included.

### PRIORITY CLAIM

The present application for Patent claims priority to Provisional Application No. 62/195,745 entitled “Graphics Offload Architecture” filed Jul. 22, 2015, and assigned to the assignee hereof and hereby expressly incorporated by reference herein.

### TECHNICAL FIELD

The technology discussed below relates in some aspects to techniques for streaming screen content from a source device to a sink device.

### BACKGROUND

With modern electronic devices, it sometimes occurs that a user desires to display content, such as video, audio, and/or graphics content, from one electronic device on another electronic device. In many instances the ability to convey the content wirelessly is also desired. Generally speaking, in such a wireless display system, a first wireless device “source device” may provide content via a wireless link to a second wireless device “sink device” where the content can be played back or displayed. The content may be played back at both a local display of the source device and at a display of the sink device.

By utilizing wireless capabilities to form a wireless connection between the two devices, a source device can take advantage of better display and/or audio capabilities of a sink device (e.g., a digital television, projector, audio/video receiver, high-resolution display, etc.) to display content that is initially stored in, or streamed to, the source device. As the demand for such technologies continues to increase, research and development continue to advance and enhance the user experience.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Various examples and implementations of the present disclosure facilitate transmission of graphics data from a source device to a sink device. According to at least one aspect of this disclosure, source devices may include a communications interface coupled with a processing circuit. The processing circuit may include logic to capture video data and capture graphics data. The processing circuit may further include logic to transmit the video data via a first protocol path, and transmit the graphics data via a second protocol path.

Further aspects provide methods operational on source devices and/or source devices including means to perform such methods. One or more examples of such methods may include obtaining video data for a frame and obtaining graphics data for the frame. The video data may be transmitted via a first protocol path, and the graphics data may be transmitted via a second protocol path.

Additional aspects provide sink devices including a communications interface coupled with a processing circuit. The processing circuit may include logic to receive video data sent via a first protocol path, and receive graphics data sent via a second protocol path. The processing circuit may further include logic to render the received video data for a frame, and render the received graphics data for the frame.

Still further aspects provide methods operational on sink devices and/or sink devices including means to perform such methods. One or more examples of such methods may include receiving video data sent via a first protocol path, and receiving graphics data sent via a second protocol path. The received video data may be rendered for a frame. Additionally, the received graphics data may be rendered for the frame.

Other aspects, features, and embodiments associated with the present disclosure will become apparent to those of ordinary skill in the art upon reviewing the following description in conjunction with the accompanying figures.

### DRAWINGS

FIG. 1 is a conceptual block diagram of an example remote display system in which a source device is configured to transmit screen content to a sink device over a communication channel, in accordance with one or more aspects of this disclosure.

FIG. 2 is a conceptual block diagram of an example remote display system in which a source device is configured to transmit screen content data to a sink device in a pixel domain transmission, in accordance with one or more aspects of this disclosure.

FIG. 3 is a conceptual block diagram of an example remote display system in which a source device is configured to transmit screen content data to a sink device in a graphics domain transmission, in accordance with one or more aspects of this disclosure.

FIG. 4 is a block diagram depicting at least one example of payload processing for audio data, video data, and graphics data from a source device to a sink device.

FIG. 5 is a block diagram of Wi-Fi Miracast data and control planes with the addition of a graphics offload (GRO) data plane according to at least one example of the present disclosure.

FIG. 6 is a flow diagram illustrating at least one example of capability negotiations between a source device and a sink device.

FIG. 7 is a block diagram illustrating at least one example of a header section of a graphics data frame for transmitting graphics data in the graphics domain.

FIG. 8 is a block diagram illustrating at least one example of a payload section of a graphics data frame for transmitting graphics data in the graphics domain.

FIG. 9 is a block diagram illustrating select components of a source device according to at least one example.

FIG. 10 is a flow diagram illustrating a method operational on a source device according to at least one example.

FIG. 11 is a block diagram illustrating select components of a sink device according to at least one example.

FIG. 12 is a flow diagram illustrating a method operational on a sink device according to at least one example.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

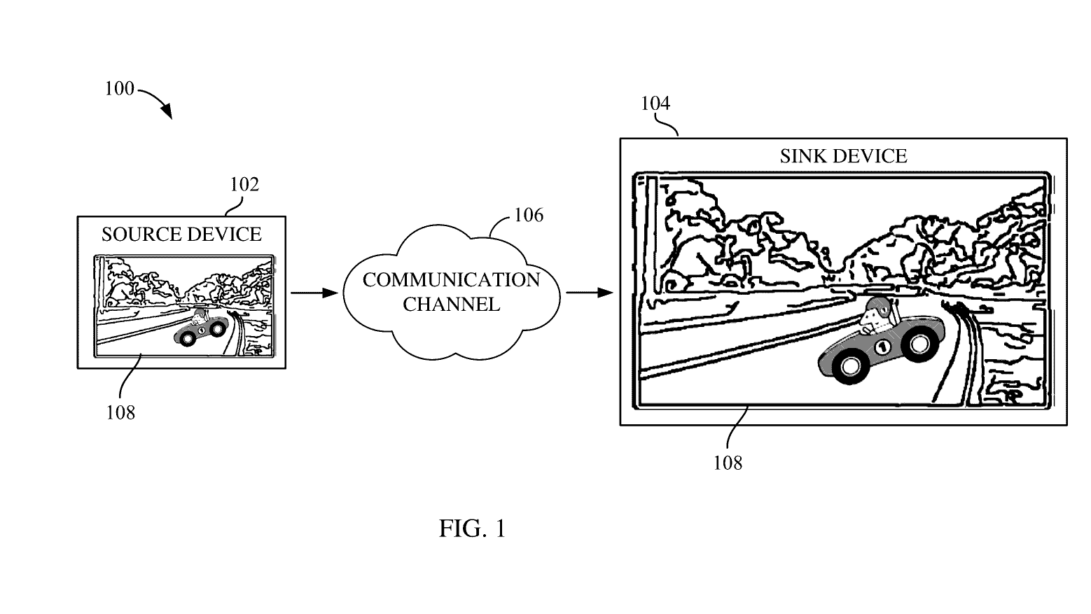

The various concepts presented throughout this disclosure may be implemented across a broad variety of wireless communication systems, network architectures, and communication standards. Referring now to FIG. 1, a conceptual diagram of an example remote display system in accordance with one or more aspects of the disclosure is illustrated. The remote display system 100 facilitates transmission of video and graphics from a source device 102 to a sink device 104 over a communication channel 106. While various aspects of this disclosure are illustrated with a remote display system utilizing a wireless communication channel, the concepts are not limited to a wireless communication channel and may be implemented with non-wireless communication channels.

The source device 102 may be an electronic device adapted to transmit screen content data 108 to a sink device 104 over a communication channel 106. Examples of a source device 102 include, but are not limited to devices such as smartphones or other mobile handsets, tablet computers, laptop computers, e-readers, digital video recorders (DVRs), desktop computers, wearable computing devices (e.g., smart watches, smart glasses, and the like), and/or other communication/computing device that communicates, at least partially, through wireless and/or non-wireless communications.

The sink device 104 may be an electronic device adapted to receive the screen content data 108 conveyed over the communication channel 106 from the source device 102. Examples of a sink device 104 may include, but are not limited to devices such as smartphones or other mobile handsets, tablet computers, laptop computers, e-readers, digital video recorders (DVRs), desktop computers, wearable computing devices (e.g., smart watches, smart glasses, and the like), televisions, monitors, and/or other communication/computing device with a visual display and with wireless and/or non-wireless communication capabilities.

The communication channel 106 is a channel capable of propagating communicative signals between the source device 102 and the sink device 104. In some examples, the communication channel 106 may be a wireless communication channel For example, the communication channel 106 may be implemented in radio frequency communications in one or more frequency bands, such as the 2.4 GHz band, 5 GHz band, 60 GHz band, or other frequency bands. In some examples, the communication channel 106 may comply with one or more sets of standards, protocols, or technologies such as wireless universal serial bus (WUSB) (as promoted by the Wireless USB Promoter Group), Wi-Fi (as promoted by the Wi-Fi Alliance), WiGig (as promoted by the Wireless Gigabit Alliance), and/or the Institute of Electrical and Electronics Engineers (IEEE) 802.11 set of standards (e.g., 802.11, 802.11a, 802.11b, 802.11g, 802.11n, 802.11ac, 802.11ad, 802.11mc, etc.), as well as one or more other standards, protocols, or technologies. The frequency bands used, such as the 2.4 GHz, 5 GHz, and 60 GHz bands, may be defined for purposes of this disclosure as they are understood in light of the standards of Wi-Fi, WiGig, any one or more IEEE 802.11 protocols, or other applicable standards or protocols. In other examples, the communication channel 106 may be a non-wireless communication channel.

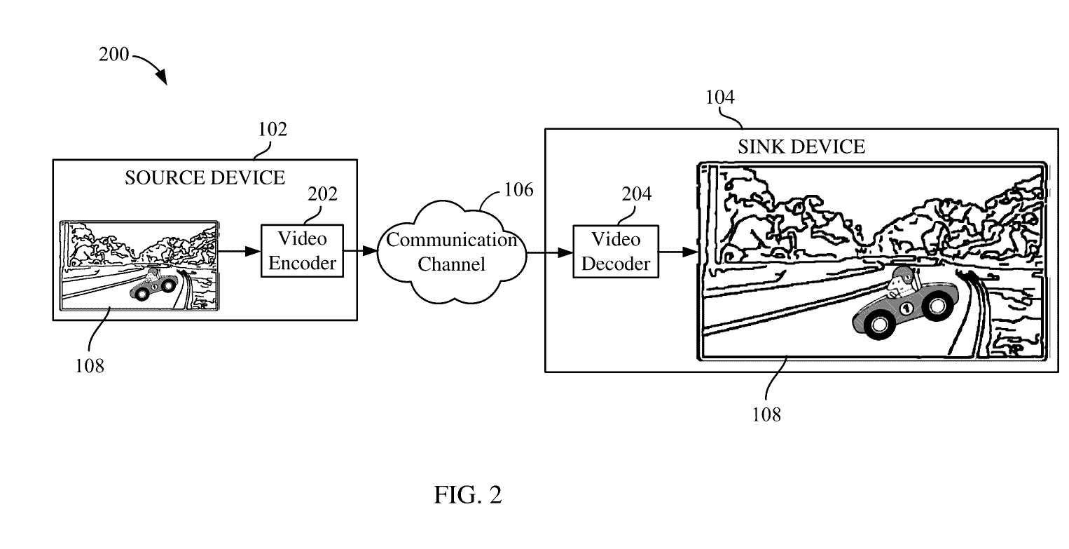

As depicted by FIG. 1, the source device 102 may have screen content data 108 to be conveyed. The source device 102 can convey the screen content data 108 via the communication channel 106 to the sink device 104. One method to convey the screen content data 108 from the source device 102 to the sink device 104 over the communication channel 106 is defined by the Wi-Fi Alliance Miracast R1 (Wi-Fi Display Technical Specification Version 1.0.0 and Version 1.1, which may be referred to herein as Wi-Fi Miracast). A traditional Wi-Fi Miracast operation 200 is illustrated in FIG. 2, employing a pixel domain transmission method to convey the screen content data 108 from the source device 102 to the sink device 104. As depicted, the screen content data 108 at the source device 102 is encoded by a video encoder 202 and transported to the sink device 104, where it is decoded by a decoder 204 and rendered. Such a Wi-Fi Miracast system typically uses H.264 video coding standard to encode the screen content data 108 and typically facilitates screen resolution up to 1920×1080.

In many applications, such as computer applications including games, navigation maps, and productivity software(s), the screen content data 108 includes graphics content (or graphics data) with multiple textures and high frequencies. Sometimes the screen content data 108 is primarily graphics content and other times the screen content data 108 includes a mix of graphics content and other video content (or video data). For example, a YouTube webpage may include video content in the form of an embedded video and graphics content in the form of various graphics on the webpage, like buttons, tiles, and other graphics.

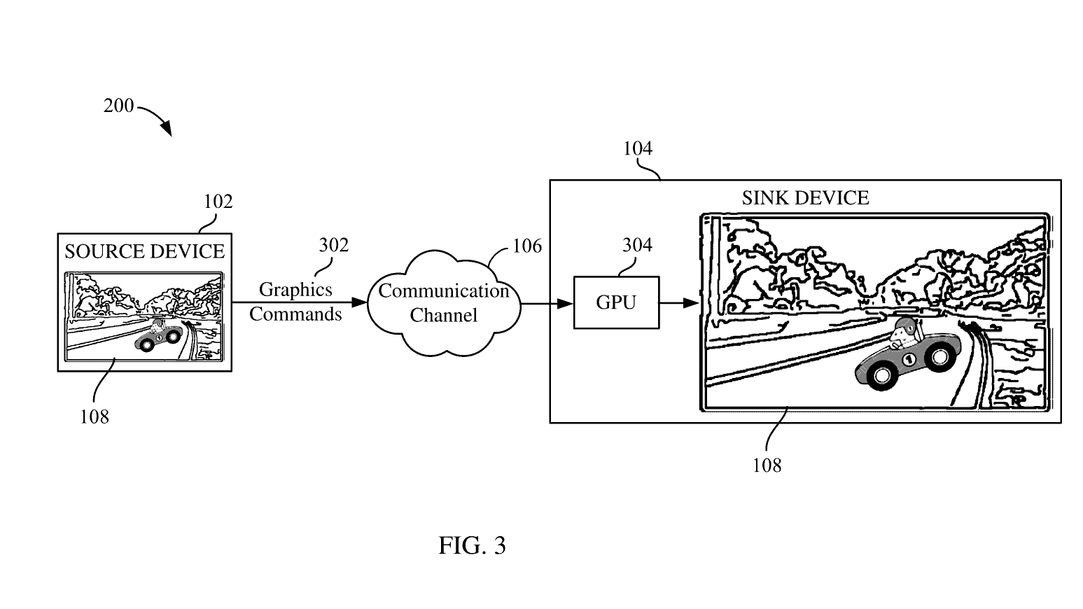

The pixel domain transmissions described above with reference to FIG. 2 may be detrimental to the graphics content because video compression artifacts tend to eliminate high frequencies and blur edges. According to aspects of the present disclosure, the graphics content may be transmitted separate from any video content in a graphics domain within the framework of a Wi-Fi Miracast system. That is, the video content (also referred to herein as “video data”) can be transmitted in the pixel domain and the graphics content (also referred to herein as “graphics data”) can be transmitted in the graphics domain. The pixel domain refers to examples where the video data is captured in the display buffer at the source device 102 and transmitted as described above with reference to FIG. 2. The graphics domain refers to examples where the graphics data is captured at the graphics processing unit (GPU) of the source device 102 and transmitted as described with reference to FIG. 3.

FIG. 3 illustrates an example of transmitting graphics data utilizing a graphics domain transmission method. As shown, the source device 102 can convey at least some of the screen content data 108 via the communication channel 106 to the sink device 104 utilizing a “graphics domain” transmission method to stream deconstructed video frames to the sink device 104. Graphics domain transmissions are different from pixel domain transmissions and may be accomplished by capturing the screen content data 108 at the source device (e.g., at an input of a GPU of the source device 102) in the form of graphics commands 302 including tokens and texture elements (e.g., tokens of OpenGL/ES commands or vendor-specific commands), and conveying the graphics commands to the sink device 104. A GPU 304 at the sink device 104 may render the graphics commands into displayable frames, and output the rendered frames at a display of the sink device 104.

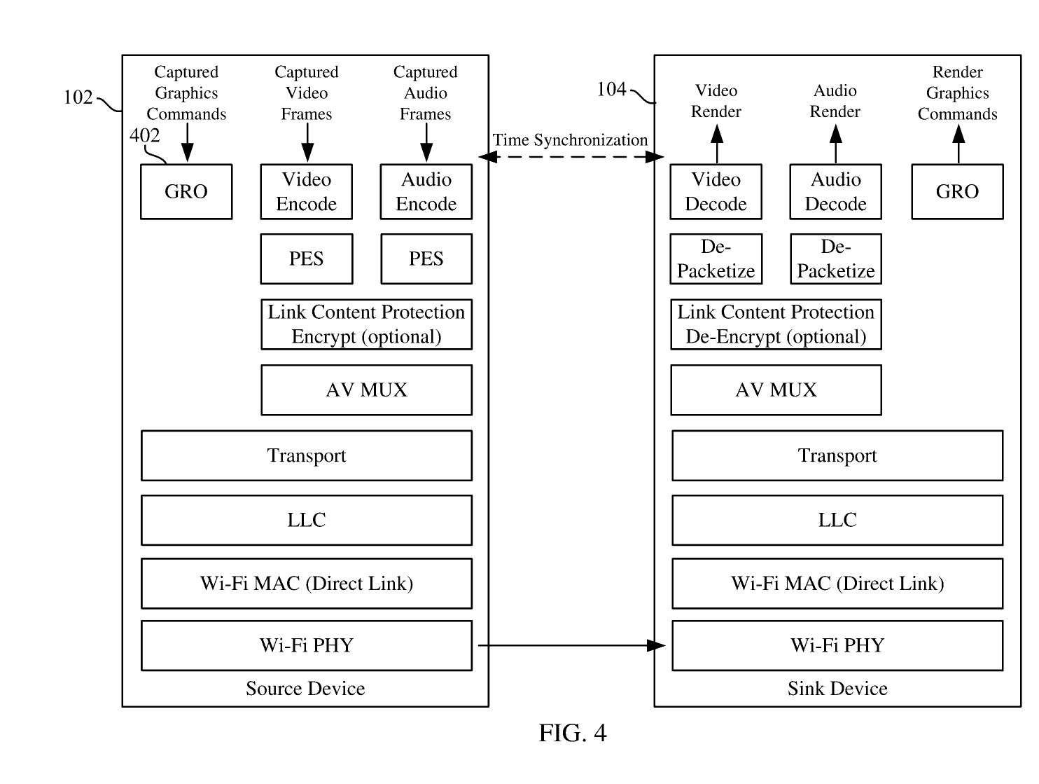

Aspects of the present disclosure facilitate the graphics domain transmission within the Wi-Fi Miracast framework. In at least one example, the graphics data can employ a different protocol path (flow) from the protocol path (flow) employed for video data and/or audio data within the Wi-Fi Miracast framework. For example, FIG. 4 illustrates a block diagram depicting at least one example of payload processing for audio data, video data, and graphics data from the source device 102 to the sink device 104. As shown, graphics data, video data, and/or audio data can be captured at the source device 102 for a particular frame. The video data and/or audio data is encoded and then packetized using conventional packetized elementary stream (PES) before optional encryption and audio/video multiplexing prior to being provided to the lower layers. According to an aspect of the present disclosure, the graphic data is captured as noted above with reference to FIG. 3. The captured graphics data can be provided to a graphics offload (GRO) subsystem 402 responsible for the graphics domain transmissions described above with reference to FIG. 3. From the GRO subsystem 402, the graphics data is provided directly to the transport layer, without any encoding and packetized elementary stream (PES) packetizing or other additional processing. The processed video data and audio data are also provided to the transport layer. The graphics data, processed video data, and processed audio data for the frame can be provided from the transport layer to the logic link control (LLC) layer, then to the medium access control (MAC) layer, and then to the physical layer (PHY) where it is transmitted to the sink device 104.

The sink device 104 receives the graphics data together with the video data and/or audio data at the physical layer and conveys it to the MAC layer, followed by the LLC layer and then the transport layer. The received graphics data can be provided from the transport layer directly to the GRO subsystem 402 of the sink device 104, and the graphics data can be rendered by a GPU of the sink device 104, as described above with reference to FIG. 3. The video data and the audio data, on the other hand, are processed by the AV multiplexing layer, decrypted if needed, de-packetized and then decoded before being rendered at the sink device 104. The processing of the video data and the audio data at the source device 102 and the sink device 104 depicted in FIG. 4 is detailed in the Wi-Fi Display Technical Specification Version 1.1 published by the Wi-Fi Alliance, which is incorporated herein by this reference. Accordingly, the specifics are not included in this disclosure.

As shown in FIG. 4, time synchronization can be employed to ensure that the graphics data, video data, and/or audio data are presented appropriately. The graphics data stream may carry a timestamp derived in similar fashion as the presentation timestamp (PTS) from the program clock reference (PCR) described in the MPEG2-TS specification. In some aspects, the source device 102 and the sink device 104 may be synchronized to a global clock source such that the devices can regulate the time a particular frame is to be rendered and playback on a display or screen. In one example, the source device 102 and the sink device 104 may be synchronized to a suitable clock source using the Network Time Protocol (NTP). In one example, the source device 102 and the sink device 104 may be synchronized to a clock source using the Timing Synchronization Function (TSF) from the same Wi-Fi network (e.g., IEEE 802.11mc) to which both devices are connected. If the content or data to be streamed contains audio, both audio and video are synchronized on the sink side. In one aspect of the disclosure, the audio component may be captured early on the source side at the application layer. When audio packets arrive at the sink side, they are synchronized to the same global clock source used to synchronize the video playback (e.g., NTP, TSF, or IEEE 802.11mc).

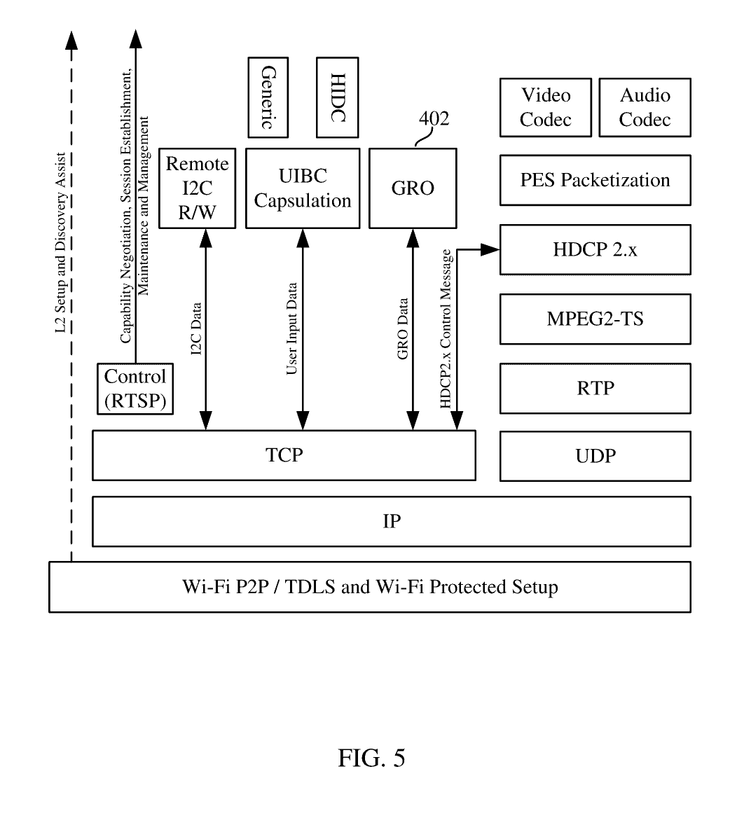

A more detailed example of the data and control planes for Wi-Fi Miracast modified to include graphics domain transmissions described herein is depicted in FIG. 5, which illustrates the functional blocks of the Wi-Fi Miracast data and control planes, including a graphics offload (GRO) data plane according to at least one example of the present disclosure. Most of the functional blocks of the depicted data and control planes are described in detail in the Wi-Fi Display Technical Specification Version 1.1 noted above. Accordingly, such details will not be laid out in this disclosure. In general, the data plane can include a video codec, audio codec, Packetized Elementary Stream (PES) packetization, the High-bandwidth Digital Content Protection (HDCP) system 2.x, and Moving Picture Experts Group encoding (MPEG2-TS) all over Real-time Transport Protocol (RTP)/User Datagram Protocol (UDP)/Internet Protocol (IP). The control plain can include Real Time Streaming Protocol (RTSP) over Transmission Control Protocol (TCP)/IP, remote I2C read/Write, User Input Back Channel (UIBC) with Human Interface Device Class (HIDC) and generic user input, and the HDCP session key establishment. The Wi-Fi P2P/Tunneled Direct Link Setup (TDLS) block forms the layer-2 connectivity using either Wi-Fi P2P or TDLS. As noted, the details of each of these bocks are well known and set forth in detail in the above referenced specification.

According to an aspect of the present disclosure, the conventional data and control planes for the Wi-Fi Miracast framework can be modified to further include the graphics offload (GRO) subsystem 402 responsible for the graphics domain transmissions described above with reference to FIG. 3. As shown in FIG. 5, the GRO subsystem 402 is configured with its data plane over TCP/IP. As a result, a different protocol path (flow) can be used for graphics data as compared to the protocol path (flow) for video and/or audio data. In this example, the video data is communicated via a first protocol path that includes PES packetization and MPEG coding communicated over RTP/UDP/IP, while the graphics data is communicated via a second protocol path that employs TCP/IP. The graphics data is therefore not subject to PES packetization and MPEG coding. Accordingly, better latency and/or reliability can be achieved as compared to a scenario where the graphics data, the video, and the audio are communicated via the same protocol path.

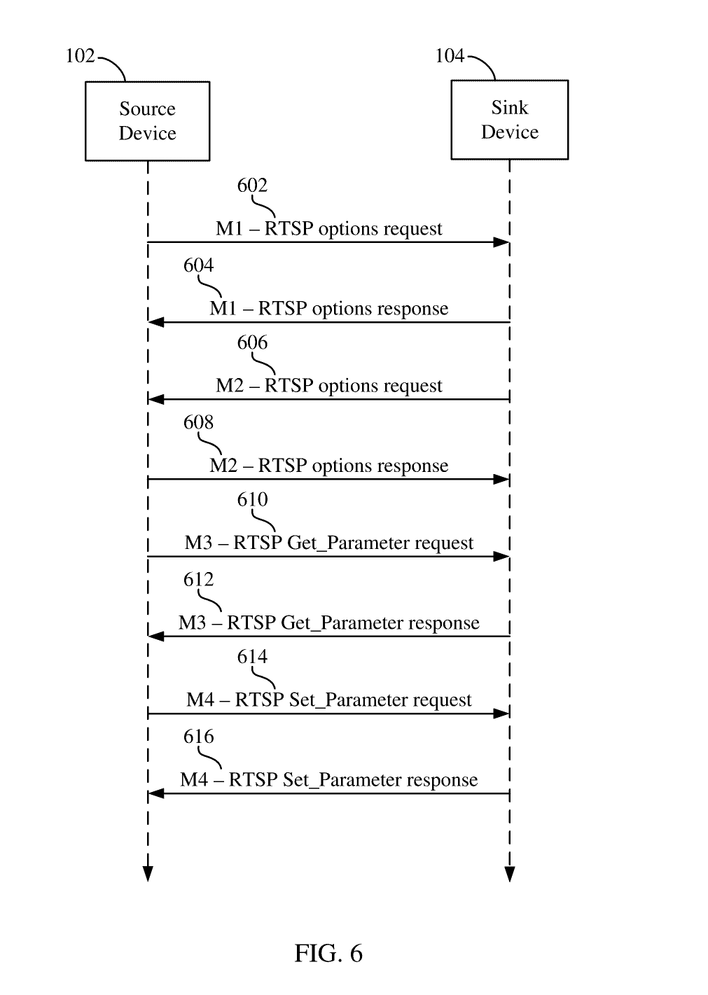

According to an aspect of the present disclosure, the source device and sink device can employ capability negotiations to determine whether both devices have the capability to communicate in the graphics domain and the pixel domain. FIG. 6 is a flow diagram illustrating at least one example of capability negotiations between the source device 102 and the sink device 104. As shown, following a successful completion of L3 connectivity, and with both devices having an IP address, the source device 102 can send a Real Time Streaming Protocol (RTSP) M1 options request message 602 to the sink device 104 for determining the set of RTSP methods supported by the sink device 104. On receipt of the RTSP options request message, the sink device 104 can respond with an RTSP M1 options response message 604 that lists the RTSP methods supported by the sink device 104. After successful RTSP M1 message exchange, the sink device 104 can send an RTSP M2 options request message 606 to the source device 102 for determining the set of RTSP methods supported by the source device 102. On receipt of the RTSP M2 options request message from the sink device 104, the source device can respond with an RTSP M2 options response message 608 listing the RTSP methods supported by the source device 102.

Following a successful RTSP M2 exchange, the source device 102 sends an RTSP M3 Get_Parameter request message 610 specifying a list of capabilities that are of interest to the source device 102. According to an aspect of the present disclosure, the list of capabilities specified in the Get_Parameter request message 610 includes a parameter adapted to indicate a request for sending graphics data as described above with reference to FIGS. 3, 4, and 5, where the graphics data is sent on a different protocol path from any video data and/or audio data. The sink device 104 can respond with an RTSP M3 Get_Parameter response message 612 indicating whether the sink device 104 is capable of receiving graphics data as described herein.

Based on the RTSP M3 response, the source device 102 can determine a set of parameters to be used for the streaming display session and can send an RTSP M4 Set_Parameter request message 614 including the parameter set to be used in the streaming display session between the source device 102 and the sink device 104. When both the source device 102 and the sink device 104 support handling of graphics data transmissions, the source device 102 may include in the RTSP M4 Set_Parameter request message 614 a graphics data info parameter, which may also be referred to as a graphics offload stream info parameter. The graphics data info parameter can include the actual parameters to be used for the graphics data stream(s) during the streaming display session. On receipt of the RTSP M4 request from the source device 102, the sink device responds with an RTSP M4 Set_Parameter response message 616.

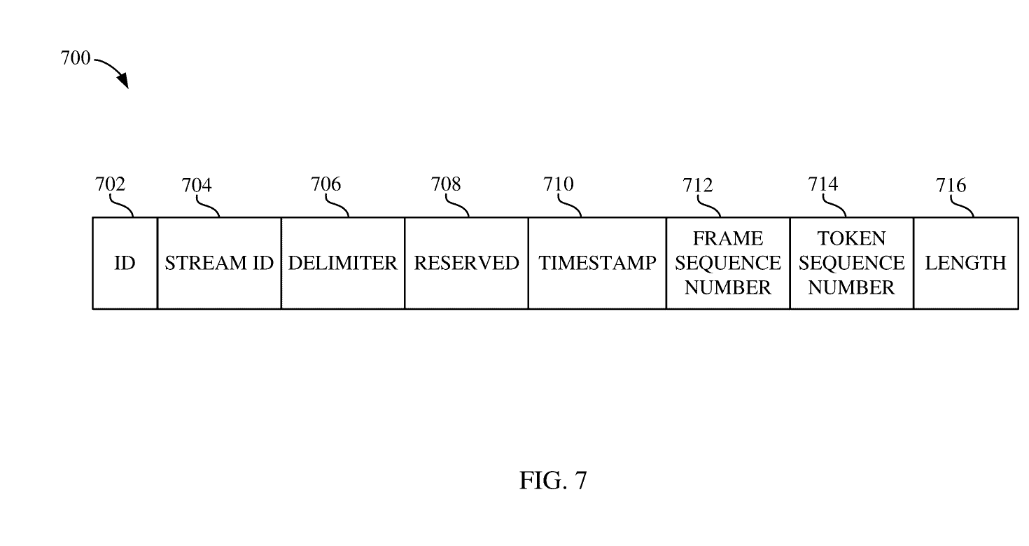

After the capabilities negotiation, and after a session is established between the source device and the sink device, the graphics data can be transmitted to the sink device in the graphics domain while the video data can be transmitted to the sink device in the graphics domain. The graphics data can be transmitted in graphics data frames including a header section and a payload section. FIG. 7 is a block diagram illustrating at least one example of a header section 700 of a graphics data frame for transmitting graphics data in the graphics domain. In the depicted example, the header section 700 includes an ID field 702 that uniquely identifies the graphics data frames. A stream ID field 704 is included to uniquely identify the graphics data stream associated with the frame. In some implementations, the source device 102 and the sink device 104 may have more than one graphics data stream in the graphics domain. The stream ID field 704 can identify to the sink device 104 which graphics data stream the frame is associated with. A delimiter field 706 may be included to identify the start and end of the graphics data frame. The header section 700 may further include a reserved field 708 and a timestamp field 710. The timestamp field 710 can be configured to indicate the presentation time for the graphics data frame to ensure time synchronization, as set forth in more detail above with reference to FIG. 4.

The header section 700 further includes a frame sequence number field 712 and a token sequence number field 714. The frame sequence number field 712 is adapted to indicate the sequence number of the graphics data frame. In at least one example, the frame sequence number field 712 can start at 0, and can increment by 1 for each new graphics data frame.

The token sequence number field 714 is adapted to indicate the token number in the graphics data frame. A single graphics data frame may include a single token, or may include multiple tokens within a single frame. In at least one example, the token sequence number field 714 can start at 1, and can increment by the number of tokens included in the graphics data frame.

In some instances, two or more graphics data frames may have the same value for the frame sequence number field 712 if they carry fragments of the same payload. In such instances, the value of the token sequence number field 714 of the graphics data frame carrying the first fragment of the payload indicates the number of tokens present in the graphics data frame, while the token sequence number field 714 of the graphics data frames carrying the remaining fragments of the payload can be set to 0. The header section 700 can include a length field 716 indicating the length of the payload section.

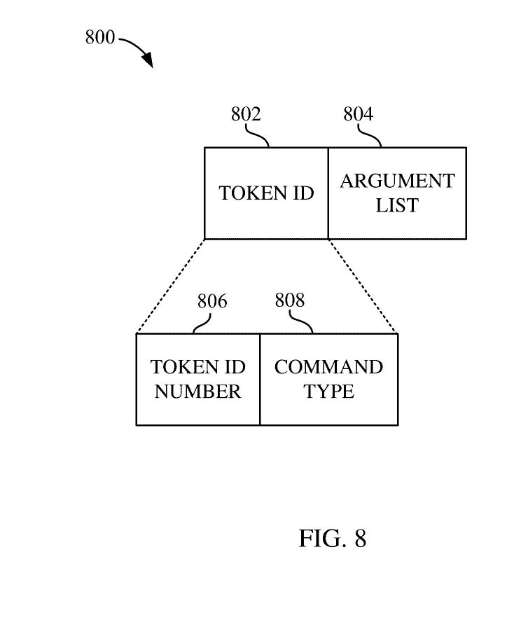

FIG. 8 is a block diagram illustrating at least one example of a payload section 800 of a graphics data frame for transmitting graphics data in the graphics domain. As shown, the payload section 800 can include a token identifier field 802 and an argument list field 804. The token identifier field 802 may include a token ID number field 806 and a command type field 808. The token ID number field 806 may include a value associated with OpenGL/ES commands or vendor-specific commands For example, with OpenGL/ES commands the value for the token ID number field 806 may be generated by parsing the OpenGL/ES header files defined by the Khronos group for various versions of OpenGL/ES. The header file parser can read each line sequentially from beginning of the file to the end of the file, assign a value for the token ID number field 806 equal to 0 for the first command (function) in the file, and increment the value of the token ID number field 806 by 1 for each new command (function) in the file. For example, a header file parser may produce two independent token ID number tables on parsing g121.h and g12ext.h OpenGL/ES 3.1 header files as set forth by the Khronos Group. The command type field 808 of the token identifier field 802 can indicate the command type of the token ID number. For example, the command type field 808 can specify whether the token is an OpenGL/ES command, an EGL command, or a vendor-specific command.

The argument list field 804 of the payload section 800 can include a list of arguments associated with the token identifier field 802. A pointer to a memory location in the argument list can be de-referenced and substituted with a length field indicating the length of the content being pointed by the pointer, followed by the actual content being pointed by the pointer. The content may be texture information, array information, shader information, etc.

By way of an example of the payload fields described above, a source device may send a frame with a value in the token identifier field 802 specifying a particular function. By way of example, the function may be a texture, a vertices, a shader, etc. Accordingly, the sink device knows that the token is associated with a texture, a vertices, a shader etc., and also knows how many arguments are associated with the specified function and what the argument types will be. Because the source device and sink device know the function type, how many arguments there will be and the argument type, the values transmitted from the source device to the sink device simply need to be parsed.

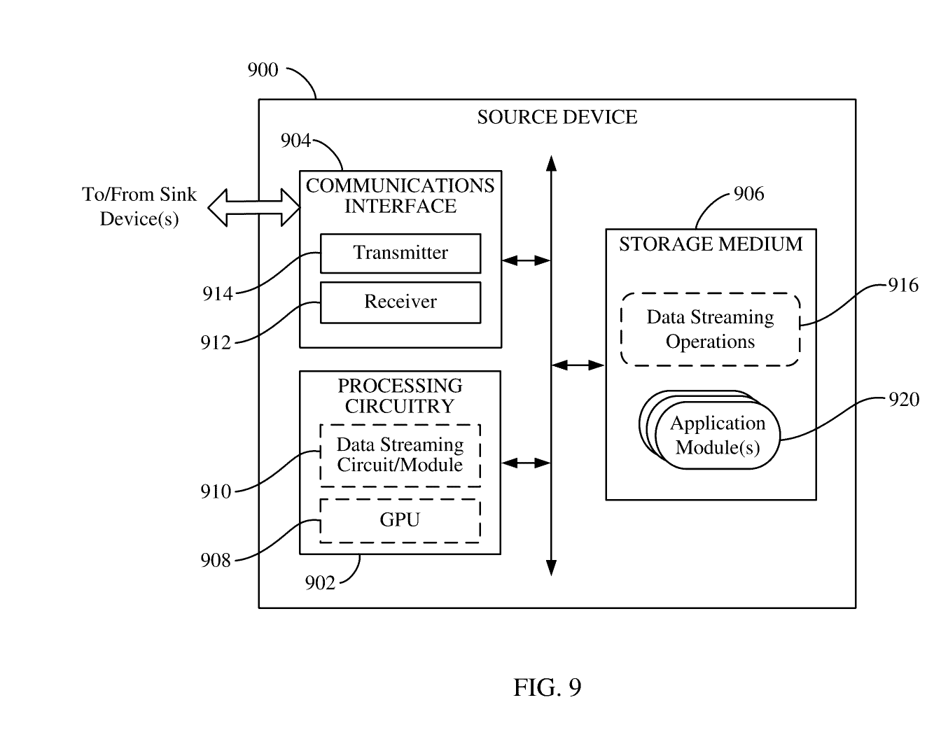

Turning to FIG. 9, a block diagram is shown illustrating select components of a source device 900 according to at least one example of the present disclosure. The source device 900 includes processing circuitry 902 coupled to or placed in electrical communication with a communications interface 904 and a storage medium 906.

The processing circuitry 902 includes circuitry arranged to obtain, process and/or send data, control data access and storage, issue commands, and control other desired operations. The processing circuitry 902 may include circuitry adapted to implement desired programming provided by appropriate media and/or circuitry adapted to perform one or more functions described in this disclosure. For example, the processing circuitry 902 may be implemented as one or more processors, one or more controllers, and/or other structure configured to execute executable programming and/or execute specific functions. Examples of the processing circuitry 902 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuitry 902 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuitry 902 are for illustration and other suitable configurations within the scope of the present disclosure are also contemplated.

The processing circuitry 902 can include circuitry adapted for processing data, including the execution of programming, which may be stored on the storage medium 906. As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuitry 902 may include a graphics processing unit (GPU) 908 and/or a data streaming circuit or module 910. The GPU 908 generally includes circuitry and/or programming (e.g., programming stored on the storage medium 906) adapted for processing graphics data and rendering frames of video data based on one or more texture elements and graphics command tokens for display by a user interface.

The data streaming circuit/module 910 may include circuitry and/or programming (e.g., programming stored on the storage medium 906) adapted to stream video data and/or graphics data to a sink device. In some examples, the data streaming circuit/module 910 may obtain video data and graphics data, where the video data is prepared for transmission via a first protocol path and the graphics data is prepared for transmission over a different second protocol path. In some examples, the data streaming circuit/module 910 may capture the graphics data at an input of a GPU, such as the GPU 908, and may capture the video data from a display buffer.

As used herein, reference to circuitry and/or programming associated with the source device 900 may be generally referred to as logic (e.g., logic gates and/or data structure logic).

The communications interface 904 is configured to facilitate wireless and/or non-wireless communications of the source device 900. For example, the communications interface 904 may include circuitry and/or programming adapted to facilitate the communication of information bi-directionally with respect to one or more sink devices. The communications interface 904 may be coupled to one or more antennas (not shown), and includes wireless transceiver circuitry, including at least one receiver 912 (e.g., one or more receiver chains) and/or at least one transmitter 914 (e.g., one or more transmitter chains).

The storage medium 906 may represent one or more processor-readable devices for storing programming, such as processor executable code or instructions (e.g., software, firmware), electronic data, databases, or other digital information. The storage medium 906 may also be used for storing data that is manipulated by the processing circuitry 902 when executing programming. The storage medium 906 may be any available media that can be accessed by a general purpose or special purpose processor, including portable or fixed storage devices, optical storage devices, and various other mediums capable of storing, containing and/or carrying programming By way of example and not limitation, the storage medium 906 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 906 may be coupled to the processing circuitry 902 such that at least some of the processing circuitry 902 can read information from, and write information to, the storage medium 906. That is, the storage medium 906 can be coupled to the processing circuitry 902 so that the storage medium 906 is at least accessible by the processing circuitry 902, including examples where the storage medium 906 is integral to the processing circuitry 902 and/or examples where the storage medium 906 is separate from the processing circuitry 902 (e.g., resident in the source device 900, external to the source device 900, distributed across multiple entities).

The storage medium 906 may include programming stored thereon. Such programming, when executed by the processing circuitry 902, can cause the processing circuitry 902 to perform one or more of the various functions and/or process steps described herein. In at least some examples, the storage medium 906 may include data streaming operations 916. The data streaming operations 916 are adapted to cause the processing circuitry 902 to stream video data and graphics data to a sink device, where the video data is streamed via a first protocol path and the graphics data is streamed via a second protocol path different from the first protocol path.

The storage medium 906 may also include application modules 920 which may each represent an application provided by an entity that manufactures the source device 900, programming operating on the source device 900, and/or an application developed by a third-party for use with the source device 900. Examples of application modules 920 may include applications for gaming, shopping, travel routing, maps, audio and/or video presentation, word processing, spreadsheets, voice and/or calls, weather, etc. One or more application modules 920 may include graphics data elements associated therewith. For example, where a gaming application of the application modules 920 entails the slicing of falling fruit (e.g., watermelons, avocados, pineapples, etc.), there may be graphics data elements (e.g., OpenGL/ES commands, vendor-specific commands) associated with the gaming application that may include a graphical representation of each of the types of fruit, as well as backgrounds. Such graphics data elements may be stored in a plurality of formats, such as RGBα 8888, RGBα 4444, RGBα 5551, RGB 565, Yα 88, and α8.

According to one or more aspects of the present disclosure, the processing circuitry 902 is adapted to perform (independently or in conjunction with the storage medium 906) any or all of the processes, functions, steps and/or routines for any or all of the source devices described herein (e.g., source device 102, source device 900), such as with reference to FIGS. 1-8 above. As used herein, the term “adapted” in relation to the processing circuitry 902 may refer to the processing circuitry 902 being one or more of configured, employed, implemented, and/or programmed (in conjunction with the storage medium 906) to perform a particular process, function, step and/or routine according to various features described herein.

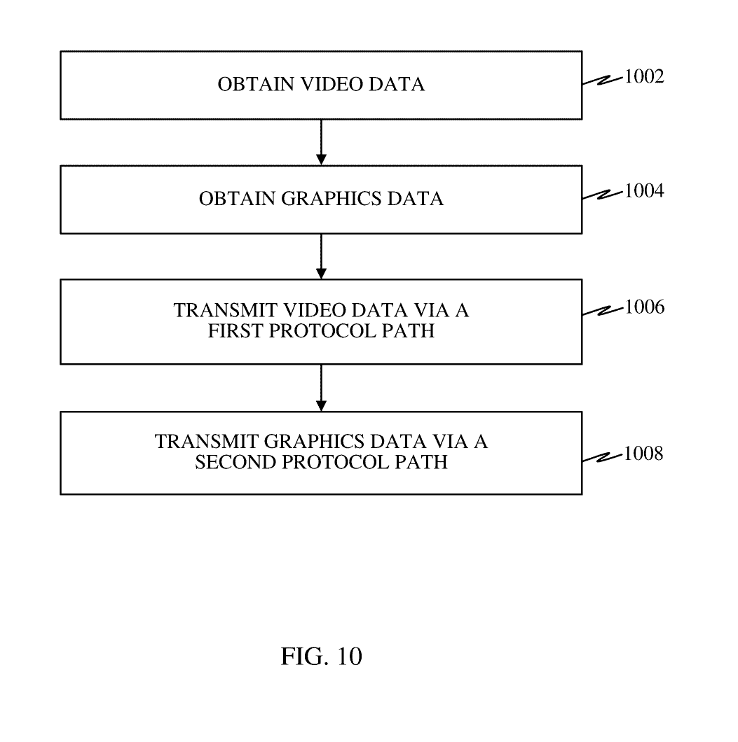

FIG. 10 is a flow diagram illustrating at least one example of a method operational on a source device, such as the source device 900. Referring to FIGS. 9 and 10, source device 900 can obtain video data at 1002. For example, the source device 900 may include logic (e.g., data streaming circuit/module 910 and/or data streaming operations 916) to capture video data for at least one frame. The video data for the one or more frames may include pixel information for rendering each pixel on a display screen. In at least one implementation, the video data may be captured from a display buffer, such as a display buffer associated with a portion of the storage medium 906. Such video data may represent pixel information to be conveyed in a pixel domain transmission.

At 1004, the source device 900 can also obtain graphics data. For example, the source device 900 may include logic (e.g., data streaming circuit/module 910 and/or data streaming operations 916) to capture graphics data for the at least one frame. The graphics data for the one or more frames may include a set of graphics command tokens (e.g., OpenGL/ES commands, vendor-specific commands) renderable into the respective frame. In at least one implementation, the graphics data may be captured at an input of the GPU 908.

At 1006, the source device 900 can transmit the video data via a first protocol path, and the graphics data may be transmitted via a second protocol path at 1008. For example, the source device 900 may include logic (e.g., data streaming circuit/module 910 and/or data streaming operations 916) to process the video data for a frame via the first protocol path as well as logic to process the graphics data for the frame via a second protocol path different from the first protocol path. In at least one example, the protocol paths may correspond to the paths described herein above with reference to FIGS. 4 and 5. For instance, the first protocol path may employ a RTP/UDP/IP path, and the second protocol path may employ a TCP/IP path. The processed video data and graphics data can be transmitted via the communications interface 904.

In at least one implementation, the source device 900 may include logic (e.g., data streaming circuit/module 910 and/or data streaming operations 916) to generate a frame including a header and payload at described above with reference to FIGS. 7 and 8 for transmitting the graphics data via the second protocol path. For instance, the header may include a frame sequence number field and a token sequence number field. Further, the payload may include a token identifier field and an argument list field.

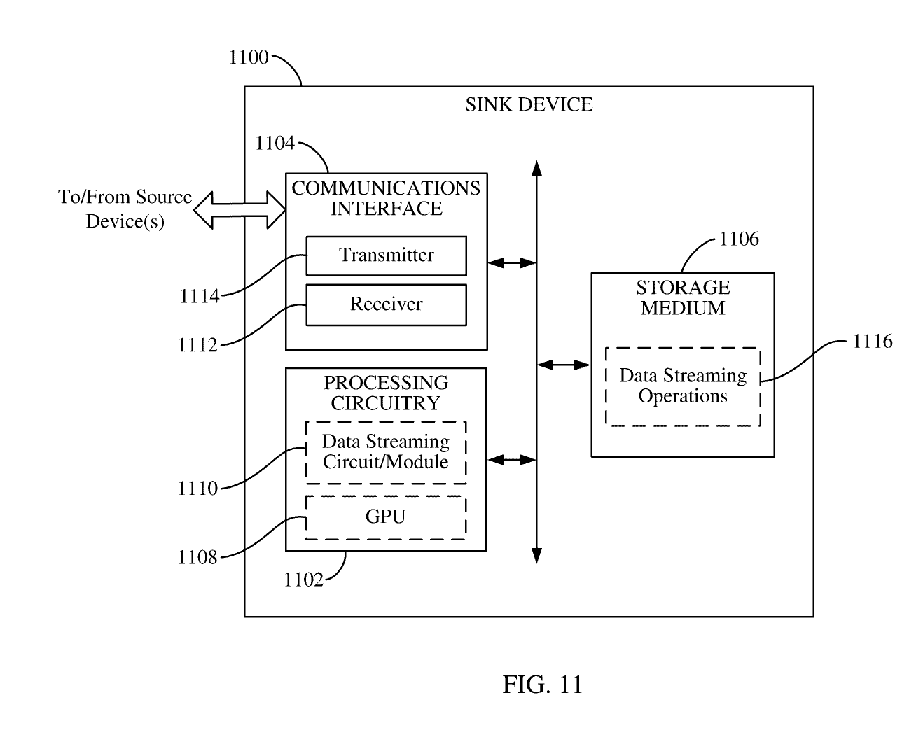

Turning now to FIG. 11, a block diagram is shown illustrating select components of a sink device 1100 according to at least one example. The sink device 1100 may include a processing circuit 1102 coupled to or placed in electrical communication with a communications interface 1104 and a storage medium 1106.

The processing circuit 1102 is arranged to obtain, process and/or send data, control data access and storage, issue commands, and control other desired operations. The processing circuit 1102 may include circuitry adapted to implement desired programming provided by appropriate media and/or circuitry adapted to perform one or more functions described in this disclosure. The processing circuit 1102 may be implemented and/or configured according to any of the examples of the processing circuit 902 described above.

In some instances, the processing circuitry 1102 may include a graphics processing unit (GPU) 1108 and/or a data streaming circuit or module 1110. The GPU 1108 generally includes circuitry and/or programming (e.g., programming stored on the storage medium 1106) adapted for processing received graphics data and rendering frames of graphics data based on one or more texture elements and graphics command tokens for display by a user interface.

The data streaming circuit/module 1110 may include circuitry and/or programming (e.g., programming stored on the storage medium 1106) adapted to receive streamed video data and/or graphics data from a source device. In some examples, the data streaming circuit/module 1110 may receive video data and graphics data, where the video data is transmitted via a first protocol path and the graphics data is transmitted over a second protocol path. The data streaming circuit/module 1110 may further render the video data for display by a user interface, and provide the graphics data to the GPU 1108 to be rendered for display by the user interface.

As used herein, reference to circuitry and/or programming associated with the sink device 1100 may be generally referred to as logic (e.g., logic gates and/or data structure logic).

The communications interface 1104 is configured to facilitate wireless and/or non-wireless communications of the sink device 1100. For example, the communications interface 1104 may include circuitry and/or programming adapted to facilitate the communication of information bi-directionally with respect to one or more source devices. The communications interface 1104 may be coupled to one or more antennas (not shown), and includes wireless transceiver circuitry, including at least one receiver 1112 (e.g., one or more receiver chains) and/or at least one transmitter 1114 (e.g., one or more transmitter chains).

The storage medium 1106 may represent one or more processor-readable devices for storing programming, such as processor executable code or instructions (e.g., software, firmware), electronic data, databases, or other digital information. The storage medium 1106 may be configured and/or implemented in a manner similar to the storage medium 906 described above.

The storage medium 1106 may be coupled to the processing circuit 1102 such that the processing circuit 1102 can read information from, and write information to, the storage medium 1106. That is, the storage medium 1106 can be coupled to the processing circuit 1102 so that the storage medium 1106 is at least accessible by the processing circuit 1102, including examples where the storage medium 1106 is integral to the processing circuit 1102 and/or examples where the storage medium 1106 is separate from the processing circuit 1102 (e.g., resident in the sink device 1100, external to the sink device 1100, distributed across multiple entities).

Like the storage medium 906, the storage medium 1106 includes programming stored thereon. The programming stored by the storage medium 1106, when executed by the processing circuit 1102, causes the processing circuit 1102 to perform one or more of the various functions and/or process steps described herein. For example, the storage medium 1106 may include data streaming operations 1116 adapted to cause the processing circuit 1102 to receive video data and graphics data from a source device, and to facilitate the rendering of the video data and the graphics data, where the received video data was sent via a first protocol path and the received graphics data sent via a second protocol path. Thus, according to one or more aspects of the present disclosure, the processing circuit 1102 is adapted to perform (independently or in conjunction with the storage medium 1106) any or all of the processes, functions, steps and/or routines for any or all of the sink devices described herein (e.g., sink device 104, 1100), such as with reference to FIGS. 1-8 above. As used herein, the term “adapted” in relation to the processing circuit 1102 may refer to the processing circuit 1102 being one or more of configured, employed, implemented, and/or programmed (in conjunction with the storage medium 1106) to perform a particular process, function, step and/or routine according to various features described herein.

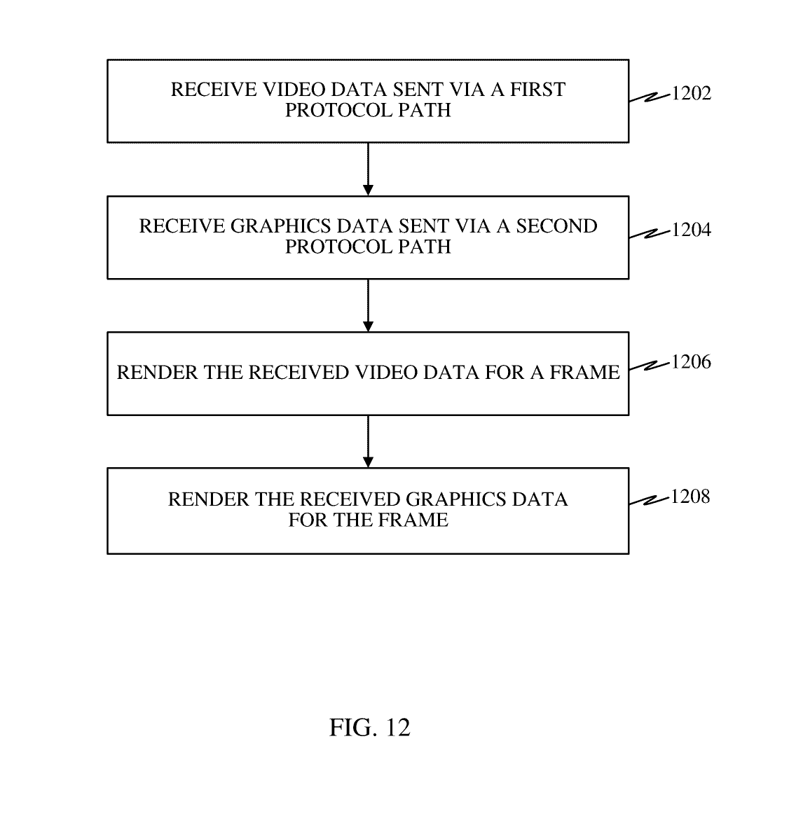

FIG. 12 is a flow diagram illustrating at least one example of a method operational on a sink device, such as the sink device 1100. Referring to FIGS. 11 and 12, a sink device 1100 may receive video data sent via a first protocol path at 1202. For example, the sink device 1100 may include logic (e.g., data streaming circuit/module 1110 and/or data streaming operations 1116) to receive video data through the communications interface 1104, where the received video data is sent via a first protocol path. In at least one implementation, the first protocol path may be a Real-time Transport Protocol/User Datagram Protocol/Internet Protocol (RTP/UDP/IP) path.

At 1204, the sink device 1100 may also receive graphics data sent via a second protocol path. For example, the sink device 1100 may include logic (e.g., data streaming circuit/module 1110 and/or data streaming operations 1116) to receive graphics data through the communications interface 1104, where the received graphics data is sent via the second protocol path. In at least one implementation, the second protocol path may be a Transmission Control Protocol/Internet Protocol (TCP/IP) path.

The graphics data may be received as one or more frames including a header section and a payload section, as described above with reference to FIGS. 7 & 8. For instance, the header section may include a frame sequence number field and a token sequence number field. Further, the payload section may include a token identifier field and an argument list field.

At 1206, the sink device 1100 may render the received video data for one or more frames. For example, the sink device 1100 may include logic (e.g., data streaming circuit/module 1110 and/or data streaming operations 1116) to render the received video data for a particular frame(s).

At 1208, the sink device 1100 may also render the received graphics data for the one or more frames. For instance, the sink device 1100 may include logic (e.g., data streaming circuit/module 1110, GPU 1108, and/or data streaming operations 1116) to render the received graphics data for the particular frame(s). In at least one example, the graphics data includes graphics command tokens (e.g., OpenGL/ES commands, vendor-specific commands) that are rendered by the GPU 1108.

While the above discussed aspects, arrangements, and embodiments are discussed with specific details and particularity, one or more of the components, steps, features and/or functions illustrated in FIGS. 1, 2, 3, 4, 5, 6, 7, 8, 9, 10, 11, and/or 12 may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in FIGS. 1, 2, 3, 9 and/or 11 may be configured to perform or employ one or more of the methods, features, parameters, and/or steps described in FIGS. 4, 5, 6, 7, 8, 10, and/or 12. The novel algorithms described herein may also be efficiently implemented in software and/or embedded in hardware.

While features of the present disclosure may have been discussed relative to certain embodiments and figures, all embodiments of the present disclosure can include one or more of the advantageous features discussed herein. In other words, while one or more embodiments may have been discussed as having certain advantageous features, one or more of such features may also be used in accordance with any of the various embodiments discussed herein. In similar fashion, while exemplary embodiments may have been discussed herein as device, system, or method embodiments, it should be understood that such exemplary embodiments can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. A source device, comprising:
a communications interface; and
a processing circuit coupled to the communications interface, the processing circuit comprising logic to:
capture video data;
capture graphics data;
transmit the video data via a first protocol path; and
transmit the graphics data via a second protocol path.

2. The source device of claim 1, wherein:
the first protocol path employs a Real-time Transport Protocol/User Datagram Protocol/Internet Protocol (RTP/UDP/IP) path; and
the second protocol path employs a Transmission Control Protocol/Internet Protocol (TCP/IP) path.

3. The source device of claim 2, wherein the first protocol path includes packetized elementary stream (PES) packetization and Moving Picture Experts Group (MPEG) coding.

4. The source device of claim 1, further comprising a display buffer of a storage medium coupled to the processing circuit, wherein the processing circuit further comprises logic to:
capture the video data from the display buffer of the storage medium.

5. The source device of claim 1, wherein the graphics data is captured at an input of a graphics processing unit.

6. The source device of claim 1, wherein the processing circuit further comprises logic to:
send a parameter request message including a request for sending graphics data via the second protocol path; and
receive a parameter response message indicating an ability to receive graphics data via the second protocol path.

7. The source device of claim 1, wherein the logic to transmit the graphics data via the second protocol path comprises logic to generate a frame including a header and a payload, wherein the header comprises a frame sequence number field and a token sequence number field.

8. The source device of claim 1, wherein the logic to transmit the graphics data via the second protocol path comprises logic to generate a frame including a header and a payload, wherein the payload comprises a token identifier field and an argument list field.

9. A method operational on source device, comprising:
obtaining video data for a frame;
obtaining graphics data for the frame;
transmitting the video data via a first protocol path; and
transmitting the graphics data via a second protocol path.

10. The method of claim 9, wherein transmitting the video data via a first protocol path comprises:
transmitting the video data via a Real-time Transport Protocol/User Datagram Protocol/Internet Protocol (RTP/UDP/IP) path.

11. The method of claim 9, wherein transmitting the graphics data via a second protocol path comprises:
transmitting the graphics data via a Transmission Control Protocol/Internet Protocol (TCP/IP) path.

12. The method of claim 9, wherein obtaining the video data for the frame comprises:
obtaining the video data from a display buffer.

13. The method of claim 9, wherein obtaining the graphics data for the frame comprises:
obtaining the graphics data at an input of a graphics processing unit.

14. The method of claim 9, further comprising:
receiving a parameter request message including a request for sending graphics data via the second protocol path; and
sending a parameter response message indicating an ability to receive graphics data via the second protocol path.

15. The method of claim 9, wherein transmitting the graphics data via a second protocol path comprises:
generating a frame including a header and a payload, wherein the header comprises a frame sequence number field and a token sequence number field.

16. The method of claim 9, wherein transmitting the graphics data via a second protocol path comprises:
generating a frame including a header and a payload, wherein the payload comprises a token identifier field and an argument list field.

17. A sink device, comprising:
a communications interface; and
a processing circuit coupled to the communications interface, the processing circuit comprising logic to:
receive, via the communications interface, video data sent via a first protocol path;
receive, via the communications interface, graphics data sent via a second protocol path;
render the received video data for a frame; and
render the received graphics data for the frame.

18. The sink device of claim 17, wherein:
the first protocol path is a Real-time Transport Protocol/User Datagram Protocol/Internet Protocol (RTP/UDP/IP) path; and
the second protocol path is a Transmission Control Protocol/Internet Protocol (TCP/IP) path.

19. The sink device of claim 17, wherein the processing circuit further comprises logic to:
receive a parameter request message including a request for sending graphics data via the second protocol path; and
send a parameter response message indicating an ability to receive graphics data via the second protocol path.

20. The sink device of claim 17, wherein the graphics data is received as one or more frames including a header and a payload, wherein the header comprises a frame sequence number field and a token sequence number field.

21. The sink device of claim 17, wherein the graphics data is received as one or more frames including a header and a payload, wherein the payload comprises a token identifier field and an argument list field.

22. The sink device of claim 17, wherein the processing circuit comprises a graphics processing unit (GPU), and wherein the GPU renders the received graphics data for the frame.

23. A method operational on sink device, comprising:
receiving video data sent via a first protocol path;
receiving graphics data sent via a second protocol path;
rendering the received video data for a frame; and
rendering the received graphics data for the frame.

24. The method of claim 23, wherein receiving video data sent via a first protocol path comprises:
receiving video data sent via a Real-time Transport Protocol/User Datagram Protocol/Internet Protocol (RTP/UDP/IP) path.

25. The method of claim 23, wherein receiving graphics data sent via a second protocol path comprises:
receiving graphics data sent via a Transmission Control Protocol/Internet Protocol (TCP/IP) path.

26. The method of claim 23, further comprising:
receiving a parameter request message including a request for sending graphics data via the second protocol path; and
sending a parameter response message indicating an ability to receive graphics data via the second protocol path.

27. The method of claim 23, wherein receiving graphics data sent via a second protocol path comprises:
receiving graphics data as one or more frames including a header and a payload, wherein the header comprises a frame sequence number field and a token sequence number field.

28. The method of claim 23, wherein receiving graphics data sent via a second protocol path comprises:
receiving graphics data as one or more frames including a header and a payload, wherein the payload comprises a token identifier field and an argument list field.

29. The method of claim 23, wherein rendering the received graphics data for the frame comprises:
rendering the received graphics data at a graphics processing unit (GPU).
